(19) United States
(12) Patent Application Publication
(10) Pub. No.: US 2010/0250024 A1
(43) Pub. Date: Sep. 30, 2010

(54) FULLY AUTONOMOUS OR REMOTELY OPERATED GOLF BALL PICKING SYSTEM

(76) Inventors: António Fernando Macedo Ribeiro, Guimaraes (PT); Carlos Duarte Oliveira E Silva, Guimaraes (PT); Ivo Mauro Correia Moutinho, Guimaraes (PT); Pedro Luis Da Costa E Silva, Guimaraes (PT); Luis Fernando Costa Pacheco, Guimaraes (PT); Sérgio Alexandre Costa De Oliveira, Guimaraes (PT); André Joaquim Barbosa Oliveira, Guimaraes (PT); Heloísa Cristiana Cardoso Costa, Guimaraes (PT)

Correspondence Address: KENEALY VAIDYA LLP, 515 EAST BRADDOCK RD SUITE B, Alexandria, VA, 22314, US

(21) Appl. No.: 12/673,769

(22) PCT Filed: Aug. 13, 2008
(86) PCT No.: PCT/PT2008/000031

§ 371 Date: Apr. 8, 2010

(30) Foreign Application Priority Data
Aug. 13, 2007 (PT) 103807

(51) Int. Cl. A63B 47/02; G05D 1/02; G01S 1/08

(52) U.S. Cl. 701/2; 701/22; 342/386

(57) ABSTRACT

The present invention regards a motorised system with electric traction with computer vision for outdoor environments, which can interact with the surrounding environment in an autonomous way or remotely operated. This vehicle tows a trailer that permits, amongst other functions, to perform golf balls picking.

### TECHNICAL FIELD

The present invention regards a motorised system with electric traction with computer vision for outdoor environments, which can interact with the surrounding environment in an autonomous way or remotely operated. This vehicle tows a trailer that permits, amongst other functions, to perform golf balls picking.

### SUMMARY OF THE INVENTION

This invention refers to a motorised system with electrical traction and computer vision for outdoor environments. This system can work autonomously or remotely operated by a wireless joystick. When in autonomous mode, it reacts accordingly to the information from the sensors and adequately executes the respective functions namely the direction to take and when to unload the container with the golf balls. This vehicle is prepared to react accordingly to the atmospheric conditions. This vehicle includes a data processor able to receive the information from the sensors, to process and control this information. This processor is connected to another processor that in turn has the main objective of image acquisition and processing from the video cameras installed in the vehicle. When remotely operated, its workstation receives the data from the sensors installed in the vehicle along with the images obtained by the video cameras, that allows avoiding obstacles automatically and to drive the robot in the intended direction (to pick the golf balls or an action performed by the trailer).

Nowadays, existing golf picking systems are not autonomous. Tractors and other kind of vehicles are utilised with towing capabilities. Besides the noise they cause, they also unable the game play in simultaneous with the ball picking. On the other side, human intervention is always necessary for the vehicle driving and for the picking and unloading of the balls as well.

Existing autonomous vehicles for outdoor environments are quite limited due to terrain irregularities, the different environment conditions such as variation of luminosity, temperature, humidity, the dimension of the play field, amongst others.

In this way, the system was prepared with the necessary characteristics to fulfil the requirements of the desired function, overtaking the above described difficulties.

As a first step, a strong mechanical structure was created to hold the whole system (weight of the balls, motors, batteries, processor units, sensors, actuators, . . . ), able to overcome irregularities of the terrain (dips, pot holes, . . . ), minimising the environmental impact (noise, game field degradation).

Since the natural illumination varies along the game field (due to the shades caused by vegetation, position and intensity of the sun rays along the day), and day by day was necessary to rely on adequate video cameras, image processing techniques (removal of static background, whites detection) in order to detect the balls.

The diameter of the vehicle wheels was dimensioned in order to be compatible with the ball picking system and the terrain characteristics.

Later on, a standing and sealed system was built to protect the processing unit, actuators and sensors.

In order to provide autonomy to the vehicle, the energy system was dimensioned, by optimising the use of this one, and also by a system for automatic charging.

Since the working area of this invention possess great dimensions, a localisation and positioning system in space was implemented.

### STATE OF TECHNIQUE

Any field to practice golf strokes—“drive in range” needs a big amount of golf balls and the means to collect them, actually is being performed by humans with the use of agriculture machinery and respective towing equipment for the purpose in hands. The need for specialised vehicles for this purpose has been increasing, not just to increase the efficiency of the process but also to reduce its costs.

Traditional systems imply an out of phase work between the golf stroke practice—“drive in range” and the maintenance of the field, since it is not possible to pick the balls at the same time that players are standing in the drive porch. The reasons are as follows: in case of manual ball picking, it is extremely dangerous for the person who picks the balls to walk on the field with players hitting golf balls (extreme violence); when the balls are picked by motorised vehicles there is still the vehicle driver in the space and also the noise is not very pleasant for the players. In that sense, the time available for picking the balls is reduced and causes great inconvenience.

The document WO2004096594 describes an autonomous vehicle of electrical traction in which its utilisation is not specified, also presenting various differences in relation to the present invention. In opposition, the traction system of the present invention characterises for being a differential electrical system. Besides that, in opposition to the invention described in document WO2004096594, the present invention works in mode autonomous and/or remote.

The document U.S. Pat. No. 4,158,418 describes a ball picking system that contains various limitation and several differences when compared with the present invention. Besides the differences in the type of construction, the type of traction is totally different from the present invention. Besides it is not motorised not having though the same easiness of manoeuvrability. The system does not permit the performing of any automatic control, nor the recording of any kind of data or statistics.

The document U.S. Pat. No. 3,520,727 describes a ball picking system of the type of a vehicle with wheels driven by a user, in which possesses two arms that stretch forward and help to pick the balls. This system has various differences to the present invention because it is not autonomous and relies on a driver to find the balls.

The document U.S. Pat. No. 5,974,348 describes a localisation system by using electromagnetic radiation sent by a minimum of six beacons (transmitters) positioned around the space, which is captured and concentrated in a panoramic image collector. The objective is to form at least seven vision lines through an electronic camera and therefore to perform its localisation using trigonometry tools. The present invention differs from this system since it uses radio frequency by signal strength and/or time of transmission.

### BRIEF DESCRIPTION OF THE FIGURES

FIG. 1 shows a general view of the whole system including the platform with the 2 wheels (1), the trailer to execute the task of picking golf balls (2), the ball picking system 83), the gate through which the balls are unloaded and the unloading dock (14).

In FIG. 2 it can be seen in detail the terminals for the autonomous battery charging (5), the system to control the power to the motors (6), a unit for continuous processing (7), a unit for image processing (9) and the vision system to perform the video capture (8).

In FIG. 3 is represented the remote joystick, which allows the platform control (robot) through its stick (10) and to visualise some system variables through its visualisation device (15).

FIG. 4 describes the localisation system by radio frequency which is made of various emitters (11) and one receptor in the robot itself (12).

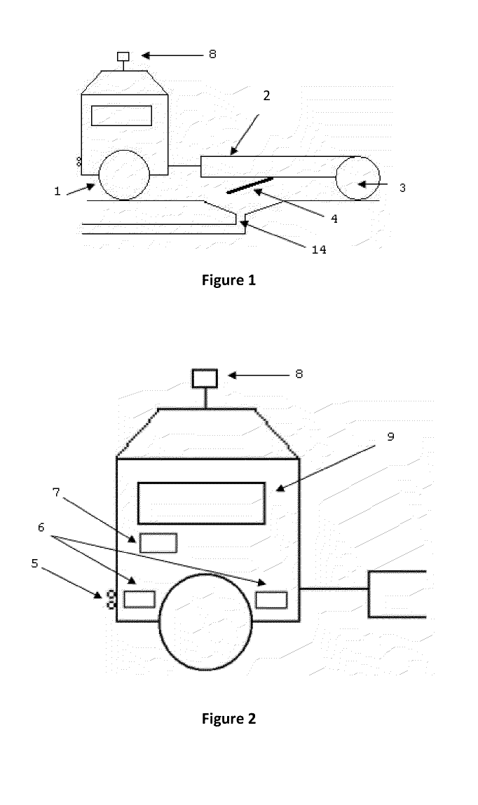

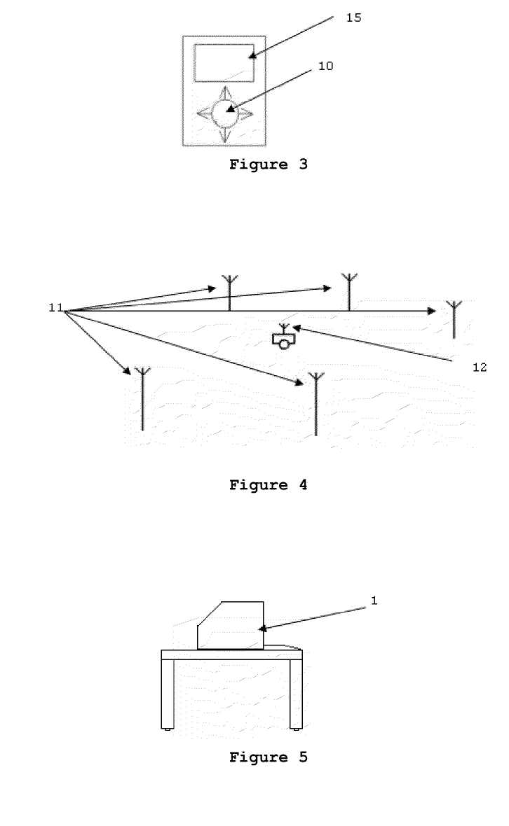

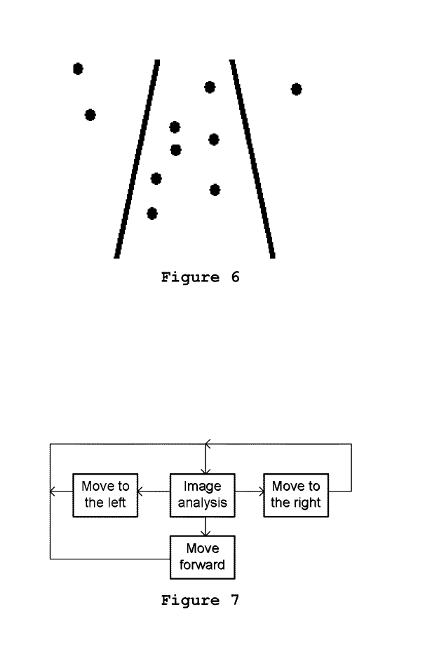

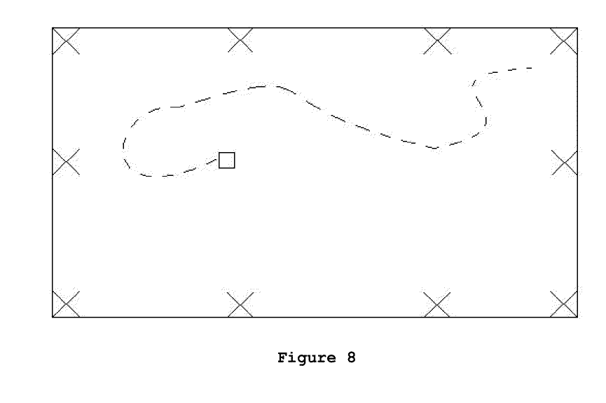

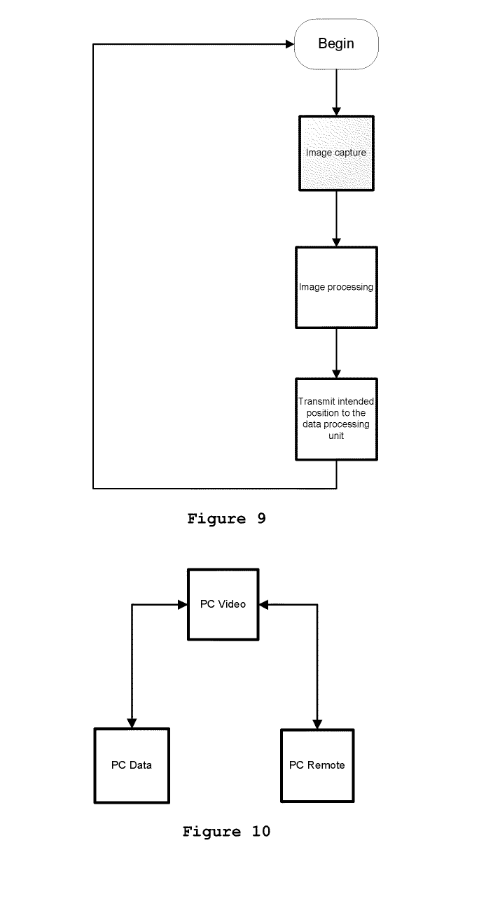

The remote visualisation/control station of the robot is represented in FIG. 5 (13).

### DESCRIPTION OF THE INVENTION

This invention comprises a dual electric motor system, a vision system and a trailer with the function of picking golf balls and collect them in a way that an automatic unload in a predefined location is possible, when a maximum load reached is detected.

The traction system is performed by an electrical differential made by two independent motors. The vision system allows the detection of game field limits, as well as detecting the zones of higher golf ball concentration—allowing taking different decisions.

For decision taking the system comprises a processing unit which interpret the signals coming from the sensors, from the obtained video camera images or from the controls actuated by a user with the joystick of similar device.

When the platform processing unit receives the video camera images and the actual localisation from the positioning sensors, defines the trajectory to follow and generates individual commands of power to be sent to each motor, in order to perform the predefined trajectory. The other existing sensors in the same sensing system will generate different behaviours on the vehicle, since this one will vary its behaviours depending on the atmospheric conditions (if the lawn is too wet the vehicle should come back to its station), from the slope of the terrain (the need to apply more or less power to the motors), the temperature variation for example (there is a maximum limit of temperature for its correct working).

This unit continuously records all the information from the sensors and system actuators, enabling it to avoid obstacles, change its behaviour depending on terrain and atmospheric conditions, to inform about the system status including battery charge level.

All data coming from sensing information is transmitted to a central where which is possible to send commands in order to trace and define trajectories to follow.

The trailer contains a ball picking system together with sensors that allow the detection of a full ball container, in order to transmit to the central system the need to proceed to ball unloading.

The unloading process is based on a gate system. This opens through an actuator when the vehicle gets to the unloading dock and activates the positioning sensors that indicate the correct position of the vehicle in relation to the automatic ball collector system. After the gate is opened, all the balls are unloaded in the automatic collector drain where are collected for washing and inserted in the ball dispenser system.

The main advantage of the ball picking system fully autonomous or remotely operated is to reduce the number of necessary balls in stock. With the actual system of back picking, manual and diary, there is no chance of picking the balls when the players are doing their practicing.

Operated remotely, the system can have characteristics of self-learning, as well as learn of difficult zones for autonomous ball picking—the boundary zones of the terrain. When autonomous it takes the decisions on its own of everything that involves the task in hand. All these functions autonomously or remotely operated are executed by adapting to the surrounding atmospheric conditions.

Another advantage of this system consists in the possibility of detecting obstacles, indexes of humidity, temperature, inclination, position, etc.

The positioning system is not limited just to the localisation of the robot inside the game field limits, but this localisation is also performed by radio frequency based in time and/or based on the signal strength received and also GPS.

Besides these above mentioned advantages, this system can charge its batteries by fuel cells or solar panels on the vehicle. It is also capable of moving to a predefined location for automatically recharge of the batteries.

### DETAILED DESCRIPTION OF THE INVENTION

The autonomous or remotely operated golf ball picking system comprises the following elements:
Base (1) with two or more wheels driven separately and where the power is controlled by appropriate electronics (6);
Trailer with a ball picking device (3) and container (2) with automatic opening system (4);
Batteries (5) charged by external terminals, fuel cells and/or solar panels located on device;
Continuous data processing unit (7) for the sensor reading and the commands for the motors—PC DATA;
Vision system (8);
Image processing unit (9)—PC VIDEO;
Remote device, joystick or similar (10) with a visualisation device (15);
Positioning system by radio frequency, emitters (11) and receivers (12);
Visualisation/control unit of remote parameters (13).

The platform has two wheels (1), each attached to its respective motor. The continuous processing units (7) and of image (9) are positioned above the base. The electronic components necessary to the functioning of the complete system are connected directly to the continuous processing system (7), staying only the image control/processing in the respective processing unit (9). The motors and processing units are powered by independent batteries.

The continuous processing unit (7) guarantees total control of the robot making it to reply in emergency situations transmitted by the sensors in a correct and functional way.

The autonomous control is implemented based in the image capture and processing from the vision system (8). This implements routines of searching for golf balls along with colour calibration and establishes trajectories depending on the information acquired by the processing.

Trajectories are also autonomously implemented for the unloading dock to charge the batteries (5) and to unload the ball container (2). When the balls are unloaded the robot gets in position in the predefined location adapting to the information obtained from the respective positioning sensors.

The command device (10) may also work in simultaneous with the remote visualisation/control unit (13), thus allowing a control based on image acquisition and sensing fusion. This device emits a signal to the receptor in the continuous processing unit (7) with the relevant information to the movement intended to the motors.

The remote visualisation/control unit (13) is necessary to allow the remote access to all the critical data of the system, namely the captured images, the trajectory history, the battery charge history, the ball container load level, the values of different sensors and actuators.

The trailer has an unloading system based in a gate opening (4). The container is dimensioned in order to allow a full unload of the balls in the unloading dock (14). This is made of actuators that allow the opening of the gate.

The positioning system by radio frequency is based on a set of points (emitters (11)) positioned strategically on the terrain in order to transmit data to the continuous processing unit (receiver (12)) and to inform the position of its own.

Typically in an image captured by the frontal camera of the present invention, one can observe two bars essentially horizontal that limit the ball picking area of the system, as it can be seen in FIG. 6.

In this way, the systems learn that the recognised balls should rely inside the referred bars and therefore all the balls inside this region should be picked.

At every moment the decisions are taken by the vehicle according the analysis on the captured image, as it is presented in the flowchart of FIG. 7.

The trajectory to follow by the system on the game field is defined by the processing system and depends on the location of the golf balls on the terrain. The system only has to pass by a set of points to be defined previously as points of control—“check points”, relying on the positioning system, on which the system has to go in case the system is not able to find balls after the image analysis, or after a certain amount of time defined as the limit time—“time out”. In FIG. 8 is visible a possible trajectory taken by the system on the game field.

Following the trajectory, the system receives information from various sensors reacting in the case of detecting obstacles, for example using ultra-sounds, predefined values of humidity or excessive temperature. In case of an excessive terrain slope exceeding a predefined value or a collision is detected, the speed should decrease, for example using an accelerometer. In case of wrong orientation of the system in an extreme position of the game field, the system can fall back, for example, on a compass indicating to system the right direction according to the positioning system.

In case the system exceeds the ball limits collected or it is necessary to recharge the batteries, it should be able to guide itself to the unloading dock. To all this description of system behaviours based on information received from sensors, is named sensing fusion.

In general the image processing consists in separating the background (lawn in this case) from the white dots (the golf balls), following the relative position calculation of the white dots in order to communicate to the data processing unit the position and speed that should be given to the motors to pick the golf balls, as it is shown in FIG. 9.

The communication between the various processing devices—the data processing unit, the video processing unit and the remote control unit, see FIG. 10—is based in a protocol of request followed by an answer, and this protocol uses the following steps:

1—PC Data (7) transmits data to PC Video (9);
2—PC Video (9) transmits data request to PC Data (7) and receives the respective data, transmits data and image to PC Remote;
3—PC Remote requests and receives video and data from PC Video (9) and also transmits instructions of motor actuation to PC Video (9) that in turn relays to PC Data (7).

### Example

The PC remote transmits to PC Video (9) the instruction to move at velocity V and direction X, Y and in turn PC Video (9) receives the request and communicates with PC Data (7) that actuates the motors in the respective way.

It should be clear that the examples of the fully autonomous or remotely operated golf ball picking system described previously are just simple possible examples of implementation, merely established for a clear understanding of the basic principles of the invention.

Variations and modifications to the previously referred examples can be performed as long as they do not deviate substantially from the spirit and principles of the invention. All the modifications and variations should be included in the scope of the present invention.

1. Fully autonomous golf ball picking system comprising:
One base with, at least, two linked wheels, being each one moved by an independent motor;
One vision system with a variable number of cameras
One set of sensors—humidity, accelerometer, compass, encoders, temperature, ultrasounds, GPS, that allow the optimisation of the path of the system;
One processing unit for image acquisition and processing;
One continuous data processing unit from data coming from sensors and control of the motors;
One trailer with a mechanical device for picking the balls and a ball container with an automatic opening system;
One battery unit rechargeable by external terminals

2. System of claim 1, wherein the rechargeable batteries are charged by fuel cells or solar panels presents on the device.

3. System of claim 1, wherein the motors are controlled directly via “remote control” through a command device, joystick or similar with a visualisation device.

4. System of claim 1, further comprising locating the system in a golf game field by means of radio frequency based on time and/or based on the received signal strength and also by GPS; where a set of emitter points positioned strategically on the game field in order to transmit data to the continuous processing unit via a receiver above the system.

5. System of claim 1, wherein the independent motors create between them a differential that allows different speeds on the wheels to allow change of direction of the system.

6. System of claim 1, further comprising having a connection with a remote central on which receives all the sensor information, as well as visualisation of the records made by the processing unit and where is also possible the sending of commands to the system.

7. System of claim 6, further comprising limiting on the image received by the vision system the zones that are in the path of the ball picking device.

8. System of claim 1, further comprising a continuous data processing unit for sensor reading and motor commands to calculate new trajectories to: avoid obstacles; pick a greater number of balls; move to the unloading dock.

9. System of claim 1, further comprising possessing a localisation system of radio frequency based on time and/or based on the signal strength.

10. System of claim 1, further comprising unloading automatically the golf balls in the unloading dock.

11. System of claim 1, further comprising having the motors and processing units powered by independent batteries.

12. Process of picking balls in accordance with the system of claim 1, comprising:
Image processing separating the background with the lawn form the white dots as the golf balls;
Calculation of the relative position of the golf balls
Communication to the continuous data processing unit of the position and speed that should be given to the motors in order to pick the golf balls.
